(19) United States
(12) Patent Application Publication
(10) Pub. No.: US 2002/0070320 A1
(43) Pub. Date: Jun. 13, 2002

(54) Television support

(76) Inventor: Steve Huang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/734,171

(22) Filed: Dec. 12, 2000

(51) Int. Cl. F16M 11/32; B62B 1/00

(52) U.S. Cl. 248/129; 280/47.24

(57) ABSTRACT

A television support for supporting a television includes a base including opposite first and second sides. A T-shape member is securely attached to the first side of the base. A V-shape member is securely attached to the second side of the base. The T-shape member is preferably located in a middle between two limbs of the V-shape member when viewed by a watcher of a television supported by the television support.

### BACKGROUND OF THE INVENTION

1. Field of the Invention

The present invention relates to a television support that represents a “T” and a “V”.

2. Description of the Related Art

A television is almost a necessity in the modern world. FIG. 1 of the drawings illustrates a conventional television support for supporting a television, which is more or less monotonous. The present invention is intended to provide a television support that represents a “T” and a “V” to appeal the watcher.

### SUMMARY OF THE INVENTION

The present invention provides a television support for supporting a television, wherein at least a portion of the television support representing a “T” and a “V”.

A television support for supporting a television in accordance with the present invention comprises a base including opposite first and second sides. A T-shape member is securely attached to the first side of the base. A V-shape member is securely attached to the second side of the base.

The T-shape member is higher than the V-shape member. The T-shape member is preferably located in a middle between two limbs of the V-shape member when viewed by a watcher of a television supported by the television support. The base includes a plurality of casters mounted thereto. The V-shape member includes two limbs and the T-shape member includes a vertical section. An upper support is securely attached between an upper portion of each limb of the V-shape member and an upper portion of the vertical section of the T-shape member. A mediate support is securely attached between a mediate portion of each limb of the V-shape member and a mediate portion of the vertical section of the T-shape member. The mediate support, the upper support, and the base are preferably in the form of a plate. The mediate support is smaller than the upper support, and each of the mediate support and the upper support includes two sides that are respectively hidden behind the limbs of the V-shape member when viewed by the watcher.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional television support.

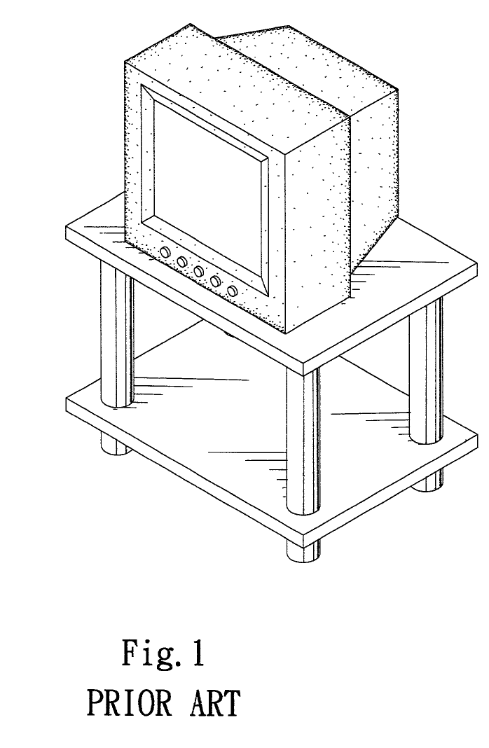

FIG. 2 is an exploded perspective view of a television support in accordance with the present invention.

FIG. 3 is a perspective view of the television support in accordance with the present invention.

FIG. 4 is a front elevational view of the television support in accordance with the present invention.

FIG. 5 is a perspective view of a modified embodiment of the television support in accordance with the present invention.

### DETAILED DESCRIPTION OF THE PREFERRED EMBODIMENT

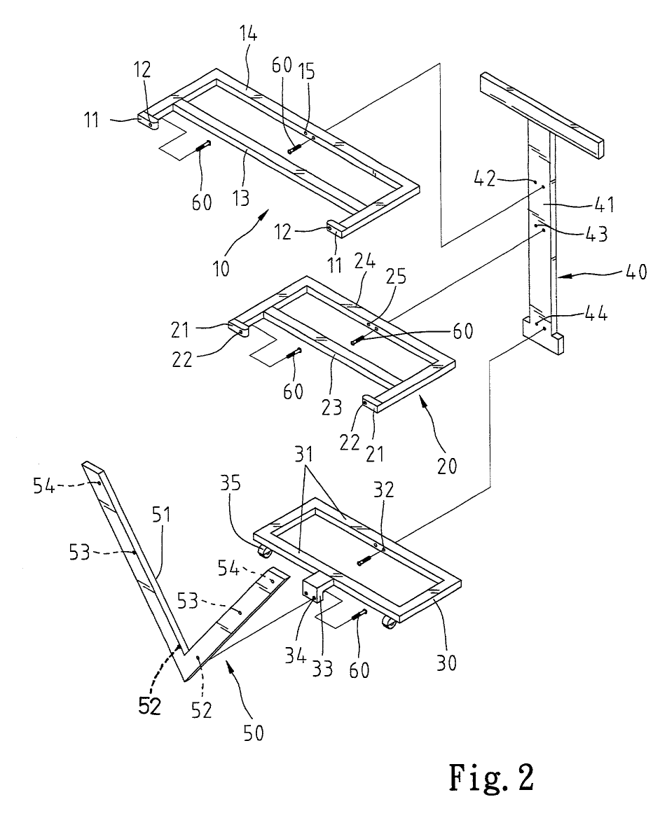

Referring to FIGS. 2 through 4, a television support in accordance with the present invention generally includes a substantially rectangular base 30 having casters 35 mounted thereto to allow easy movement of the base 30. A substantially T-shape member 40 is attached to, e.g., a rear side of the base 30 by means of extending fasteners (not labeled) through holes 32 in a rear side beam 31 of the base 30 and screw holes 44 in a lower end of a vertical section 41 of the T-shape member 40. A substantially V-shape member 50 is attached to, e.g., a front side of the base 30 by means of extending fasteners 60 through holes 32 in an extension 33 extended from a front side beam 31 of the base 30 and screw holes 52 in a lower end of the V-shape member 50.

Mounted between a mediate portion of the vertical section 41 of the T-shape member 40 and a mediate portion of each of two limbs 51 of the V-shape member 50 is a substantially rectangular mediate support 20. The mediate support 20 includes two engaging portions 21 each having a hole 22 through which a fastener 60 is extended for engaging with a screw hole 53 in the mediate portion of an associated limb 51. The upper support 10 further includes a beam 13 connected between two lateral beams (not labeled) thereof to provide a supporting function. In addition, fasteners 60 are extended through holes 25 in a rear side beam 24 of the mediate support 20 and engaged with screw holes 43 in the mediate portion of the vertical section 41 of the T-shape member 40.

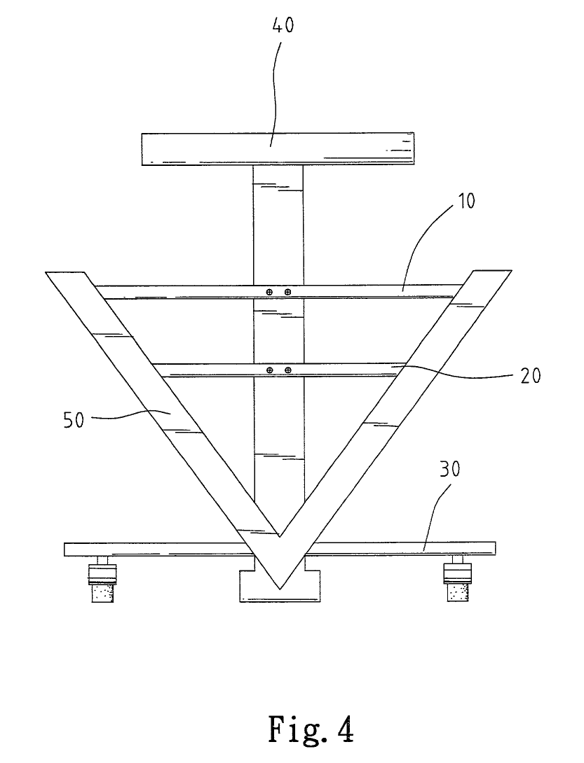

Mounted between an upper portion of the vertical section 41 of the T-shape member 40 and an upper portion of each of two limbs 51 of the V-shape member 50 is a substantially rectangular upper support 10. The upper support 10 includes two engaging portions 11 each having a hole 12 through which a fastener 60 is extended for engaging with a screw hole 54 in the upper portion of an associated limb 51. The upper support 10 further includes a beam 13 connected between two lateral beams (not labeled) thereof to provide a supporting function. In addition, fasteners 60 are extended through holes 15 in a rear side beam 14 of the upper support 10 and engaged with screw holes 42 in the upper portion of the vertical section 41 of the T-shape member 40. As illustrated in FIG. 4, the T-shape member 40 is higher than the V-shape member 50 and stands in a place (preferably the middle) between the two limbs 51 of the V-shape member 50 when viewed by the watcher. A “T” and a “V” are clearly represented by the television support of the invention.

It is appreciated that connection between the members 40 and 50, the base 30, and the supports 10 and 20 can be achieved by any suitable means other than using fasteners without departing from the scope of the invention, such as soldering, welding, mortise and tenon, etc.

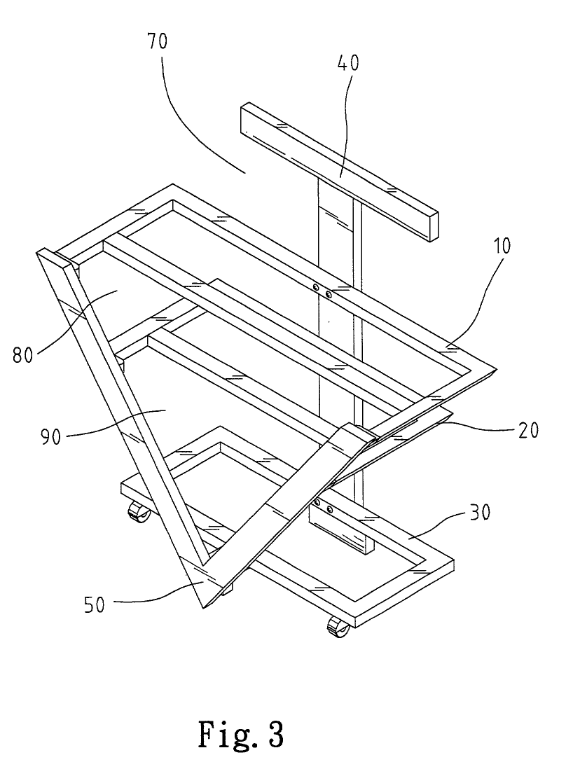

As illustrated in FIGS. 3 and 4, the mediate support 20 is smaller than the upper support 10, and the lateral side beams of the supports 10 and 20 are hidden behind the V-shape member 50 when viewed by the watcher. A television (not shown) may be placed on the upper support 10 while other articles or decorations may be placed on the mediate support 20. The television support in accordance with the present invention represents a “T” and a “V”. which may appeal the watcher.

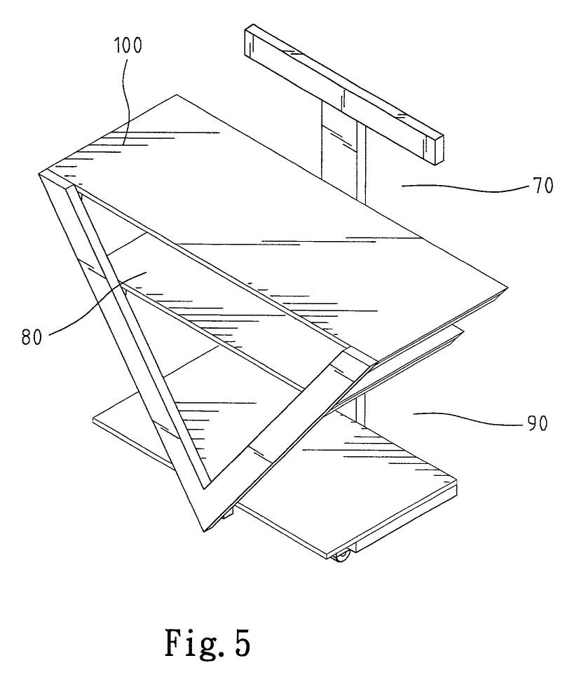

FIG. 5 illustrates a modified embodiment of the television support (now designated by 70) of the invention, wherein the upper support (now designated by 100), the mediate support (now designated by 80), and the base (now designated by 90) are in the form of a plate for supporting articles.

Although the invention has been explained in relation to its preferred embodiment, it is to be understood that many other possible modifications and variations can be made without departing from the scope of the invention as hereinafter claimed.

What is claimed is:

1. A television support for supporting a television, at least a portion of the television support representing a “T” and a “V”.

2. A television support for supporting a television, comprising:
a base including a first side and a second side opposite to the first side;
a T-shape member securely attached to the first side of the base; and
a V-shape member securely attached to the second side of the base.

3. The television support as claimed in claim 2, wherein the T-shape member is higher than the V-shape member.

4. The television support as claimed in claim 3, wherein the T-shape member is located in a middle between two limbs of the V-shape member when viewed by a watcher of a television supported by the television support.

5. The television support as claimed in claim 2, wherein the base includes a plurality of casters mounted thereto.

6. The television support as claimed in claim 2, the V-shape member includes two limbs and the T-shape member includes a vertical section, further comprising an upper support securely attached between an upper portion of each said limb of the V-shape member and an upper portion of the vertical section of the T-shape member.

7. The television support as claimed in claim 6, further comprising a mediate support securely attached between a mediate portion of each said limb of the V-shape member and a mediate portion of the vertical section of the T-shape member.

8. The television support as claimed in claim 7, wherein the mediate support is a plate.

9. The television support as claimed in claim 6, wherein the upper support is a plate.

10. The television support as claimed in claim 6, wherein the base is a plate.

11. The television support as claimed in claim 7, wherein the mediate support is smaller than the upper support, and wherein each of the mediate support and the upper support includes two sides that are respectively hidden behind the limbs of the V-shape member when viewed by the watcher.
